(19) United States
(12) Patent Application Publication
(10) Pub. No.: US 2005/0152566 A1
(43) Pub. Date: Jul. 14, 2005

(54) Electric to acoustic transducer for a hearing aid

(76) Inventors: Ulrik Mehr, Hellerup (DK); Lars Tuborg, Jensen (DK)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 10/510,767

(22) PCT Filed: Dec. 20, 2002
(86) PCT No.: PCT/DK02/00896

(30) Foreign Application Priority Data
Apr. 18, 2002 (DK) PA 2002 00574

(51) Int. Cl. H04R 25/00

(52) U.S. Cl. 381/312; 381/322; 381/324

(57) ABSTRACT

The invention comprises an electric to acoustic transducer for hearing aid with a casing containing electric to sound transducing means. The casing has at least one orifice for emitting the sound signal to the ear of a hearing aid user, where the orifice for emitting the sound signal extends along the surface of the casing and where a tubing is provided for canalizing the sound signal towards the ear of the user. The tubing comprises a sound outlet having a wide end and a narrow end and the transition from the wide end to the narrow end is gradual and the wide end embraces the orifice and is tightly joined to the casing of the receiver.

### AREA OF THE INVENTION

The invention concerns an electric to acoustic transducer for a hearing aid with a casing containing electric to sound transducing means whereby the casing has at least one orifice for emitting the sound signal to the ear of a hearing aid user. The transducer (also called a receiver) converts an electric signal into a sound signal, where the sound signal is conveyed to the ear from the transducer through a tubing system.

### BACKGROUND OF THE INVENTION

In hearing aids it is important that sound is only radiated through the tubing and not in other directions, as hearing aids also comprises a microphone. The microphone is usually located quite near the receiver, and if the sound signal from the receiver is picked up by the microphone it might lead to disturbing feed back problems. To avoid this the receiver is placed inside a casing, which is closed toward the surroundings apart from one orifice for emitting the sound. In many prior art receivers the sound-emitting orifice is shaped as a hole, and on the outside of the hole a metal snout is placed over the hole. Hereby it becomes possible to connect the tubing to the snout and thereby convey the sound signal to the ear of the user of the hearing aid. In hearing aids for people with profound healing losses, very loud sound pressures must be delivered from the receiver, and this can be a problem, especially while the hearing aid only has access to a limited power source.

From prior art document EP 0716800 a receiver is known. This receiver has a diaphragm having a plurality of peripheral edges disposed within a housing portion and defines first and second acoustical chambers. An electromagnetic motor includes an armature. A compliant bond couples the armature to the diaphragm to move the diaphragm at frequencies in accordance with an electrical signal applied to the motor. In an embodiment, the receiver has a port resulting in the receiver having a generally broad band frequency response. The port has a generally rectangular shape.

### SUMMARY OF THE INVENTION

It is the object of the invention to provide an electric to sound transducer, which even when the power source is limited will output very high sound pressures.

This is achieved with an electro acoustic transducer for a hearing aid with a casing containing electric to sound transducing means whereby the casing has at least one orifice for emitting the sound signal to the ear of a hearing aid user, where the orifice for emitting the sound signal extends along the surface of the casing and where a tubing is provided for canalizing the sound signal towards the ear of the user, where the tubing at the electric to acoustic transducer comprises a sound outlet having a wide end and a narrow end and where the transition from the wide end to the narrow end is gradual and where the wide end embraces the orifice and is tightly joined to the casing of the receiver.

The sound outlet is preferably made of polymer and covers the wide orifice, which is extending along the surface of the casing. This gives a gradual change in diameter of the soundpath from inside the receiver to the outlet, resulting in less flowresistance and higher MPO.

In a preferred embodiment the transducer comprises a sound emitting membrane and the orifice has a width, which corresponds to the size of the membrane. In this way flowresistance is minimized, and as much as possible of the sound energy radiated from the membrane is conveyed into the tubing system.

According to the invention it is preferred that the membrane is substantially square and that the orifice extends along one edge of the membrane.

### BRIEF DESCRIPTION OF THE DRAWINGS

FIG. 1 is a receiver according to the prior art,

FIG. 2 is a receiver according to the invention,

FIG. 3 is an example of a sound outlet to be used with the receiver according to the invention.

### DESCRIPTION OF A PREFERRED EMBODIMENT

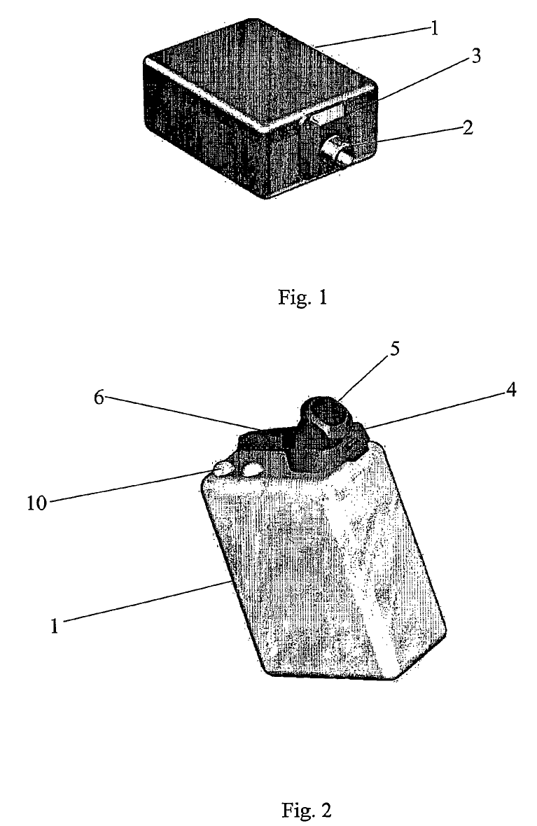

The prior art receiver in FIG. 1 has a casing 1 shaped as a rectangular box and a snout 2 placed at one end of the casing 1. The snout 2 is part of an outlet 3, which is placed over an orifice in the casing 1. A tube may be coupled to the snout 2 in order to convey the sound from the receiver to the ear.

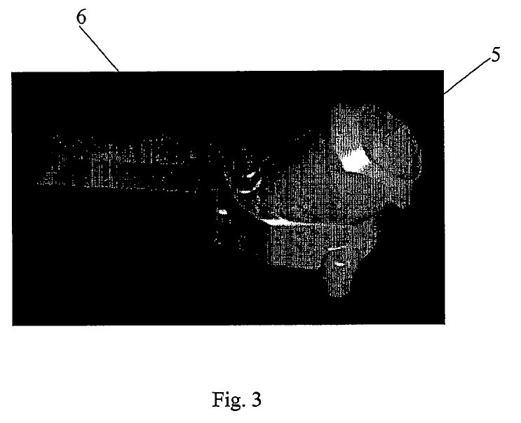

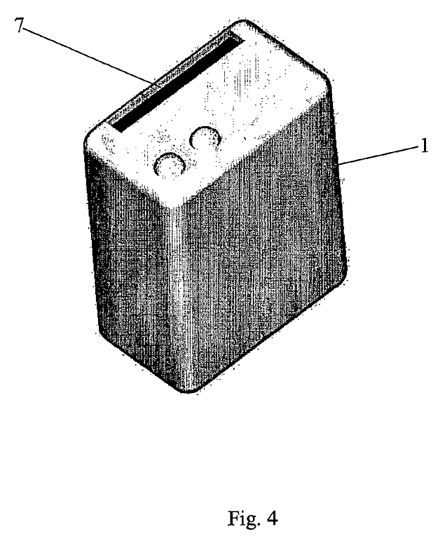

FIG. 2 shows an example of a receiver according to the invention. The receiver has a casing 1 and a sound outlet 4 placed over an orifice in the casing. As seen in FIG. 4 the orifice 7 is shaped as a wide slit, which extends along an edge part of the casing 1. In FIG. 3 the sound outlet 4 is shown and it comprises a relatively narrow snout part 5 and a wide part 6. The wide part 6 covers the slit 7 in the casing when the sound outlet is coupled to the casing. The transition from the wide part 6 to the narrow snout 5 is gradual and smooth in order to ensure the lowest possible flow resistance. In FIG. 2 solder bumps 10 are shown. Wires (not shown) with the electric input signal are soldered to the bumps.

When the receiver according to the invention is used, a rise in MPO (Maximum Power Output) from 144 dB SPL to 146 dB SPL with the same current is obtained. With an MPO of 144 dB SPL the invention makes longer battery lifetime possible.

1. Electro acoustic transducer for a hearing aid with a casing containing electric to sound transducing means whereby the casing has at least one orifice for emitting the sound signal to the ear of a hearing aid user, where the orifice for emitting the sound signal extends along the surface of the casing and where a tubing is provided for canalizing the sound signal towards the ear of the user, where the tubing at the casing comprises a sound outlet having a wide end and a narrow end and where the transition from the wide end to the narrow end is gradual and where the wide end embraces the orifice and is tightly joined to the casing of the receiver.

2. Electro acoustic transducer as claimed in claim 1, where the transducer comprises a sound emitting membrane and where the orifice has a width, which corresponds to the size of the membrane.

3. Electro acoustic transducer as claimed in claim 1, where the membrane is substantially square and where the orifice extends along one edge of the membrane.
